(19) United States
(12) Patent Application Publication
(10) Pub. No.: US 2026/0119131 A1
(43) Pub. Date: Apr. 30, 2026

(54) SYSTEMS AND METHODS FOR PROVIDING THE CREATION, REVIEW, APPROVAL, PUBLISHING, AND ANALYTICS OF WEBSITE CONTENT

(71) Applicant: Qoolo, inc., Lawrenceville, NJ (US)

(72) Inventors: Aleksandar Stojanovic, Lawrenceville, NJ (US); Miljana Stojanovic, Lawrenceville, NJ (US)

(21) Appl. No.: 19/163,687

(22) PCT Filed: Oct. 10, 2024
(86) PCT No.: PCT/US2024/050646

§ 371 Date: Sep. 9, 2025

(51) Int. Cl. G06F 8/34; G06F 3/04842; G06F 16/958; G06F 40/186; H04L 9/40

(52) U.S. Cl. CPC G06F 8/34; G06F 3/04842; G06F 16/986; G06F 40/186; H04L 63/08

(57) ABSTRACT

The invention provides systems and methods for providing a no-code, fully integrated web application providing an end-to-end solution for the design of website content, automatic generation of a detailed document in HTML or PDF format for the review and approval of content being built, approval workflow management, no-code publishing of content to a website, and analytics of website performance.

### TECHNICAL FIELD

The disclosure relates generally to website building systems and methods, and, more particularly, to systems and methods for providing a no-code, fully integrated web application providing an end-to-end solution for the design of website content, automatic generation of a detailed document in HTML or portable document format (PDF) format for the review and approval of content being built, approval workflow management, no-code publishing of content to a website, and analytics of website performance.

### BACKGROUND

Life science companies, operating in sectors such as pharmaceuticals, biotechnology, and medical devices, rely on digital communication tools to convey information about their products and research to healthcare professionals. Some primary channels through which these companies communicate include websites and interactive visual aids, such as those custom-programmed for specific platforms (e.g., Veeva CLM, IQVIA OCE, etc.). These sources of promotional or educational content often have a significant amount of content, multiple sections, and an extensive number of pages.

Life science companies must typically adhere to stringent regulatory standards when creating and disseminating content related to their products and research. For example, endnotes (which include references, footnotes and abbreviations) are unavoidable annotations from a compliance perspective. References provide the source of the information, ensuring that the content is credible and backed by scientific research. References are essential for verifying facts, supporting claims about a drug's efficacy, safety, or mechanism of action, and for maintaining transparency. Footnotes are used to give additional context, clarify complex information, or provide information without interrupting the flow of the main text. In medical documents, footnotes can explain statistical methods, the significance of study results, or any assumptions made in the analysis. Finally, medical content often includes a plethora of technical terms which can be lengthy and complex. Abbreviations help in simplifying these terms, making the documents easier to read and quicker to reference.

As a result, such content must go through a multidisciplinary review and approval process (including medical affairs, legal, regulatory, marketing, and/or compliance personnel) to ensure compliance with legal, ethical, and scientific standards. In many instances, this process is called an MLR (medical, legal, and regulatory affairs) review. After each discipline completes their respective review of the content, the content then typically undergoes a formal approval process, which may involve multiple rounds of revisions and to ensure that every aspect of the content is compliant and tailored to meet regulatory requirements and business objectives.

The current process for preparing such content for multidisciplinary review and approval can be cumbersome, as certain aspects are manual in nature. For example, regardless of whether a company uses an internal or external team to design and develop the aforementioned content, regardless of whether the content is for a website or another digital or print visual aid, and regardless of whether the software used to design that content is a desktop application (e.g., Adobe), a web application (e.g., Figma), or a no-code platform (e.g., Canva), internal or external company personnel must typically manually export images or PDFs of the content, then create a PowerPoint presentation (or other document) that shows: a visual representation of the material; the organization of content; and manually added markup that is sufficient to inform reviewers about the nature, detail, and intent of the content.

For example, in an interactive visual aid which has 50 or 100 interconnected screens, one would have to go through all pages and manually provide sufficient details so that reviewers understand which elements are clickable and to which other page or section they lead. Additionally, if an element leads to a website of some kind, that would be noted manually. In cases where there are forms (such as a contact form, a quiz, a survey, or some other input field), an individual would manually need to specify the limitations and possibilities of that input. For example, if a certain field is a drop-down selector with 20 options, those options may not be visible and would need to be listed separately as possibilities for MLR review.

Furthermore, with regard to endnotes, internal or external personnel need to manually manage endnotes (i.e., references, footnotes, and abbreviations), which essentially requires that personnel from life science companies and their vendors have adequate knowledge of the correct information, and must pass it on to one or more professionals (designers) who will enter that information into the respective software/design file (i.e., adding a symbol or superscripted number/letter on a statement of interest (also known as a “claim” or “message”) as well as a complementary list (or multiple lists) of endnotes at the bottom of pages or at the end of a material, aligned with the symbols and numbers previously implemented). Additionally, when companies create multiple materials over a period of months to years, they will often rely on many of the same endnotes. Yet, in most, if not all, of the current processes mentioned above, creation and preparation of content for review and approval starts from scratch. Endnotes are retyped manually in a new design file; symbols, numbers, and letters matching those endnotes are retyped manually; and the quality control process repeats itself. The same endnote might be typed and retyped and reused hundreds of times in a lifecycle of a single product being used by a life science company.

Accordingly, since review and approval of this type of content is usually an iterative process, in which the content may undergo multiple rounds of review and revision, the manual processing required is time consuming, costly, and can lead to unnecessary delays.

### SUMMARY

The invention of the present disclosure addresses issues currently faced by companies, specifically life science companies, with regard to regulatory standards when creating and disseminating content related to their products and research. In particular, the present invention is directed to a no-code, fully integrated web application providing an end-to-end solution for the design of website content, automatic generation of a detailed document in HTML or PDF format for the review and approval of content being built, approval workflow management, no-code publishing of content to a website, and analytics of website performance.

For example, the present invention is generally directed to a website creation and management system configured to provide a digital platform comprising an interface with which a user can interact for the creation and management of a website. The user is able to design a website and subsequently generate a detailed document (i.e., storyboard) to undergo review and approval process (before the website is published) so as to make sure such content provided meets any regulatory standards.

For example, the user may utilize the user interface (UI) provided via the platform to first determine the type of website that will be built. Once the type of website is decided, the user is able to create/design various types of website content (e.g., text, images, videos, etc.) by entering data in the application using a specific no-code builder. Upon saving individual website content, the system stores the content as data in a proprietary database, where individual elements are separately saved for easy referencing. The layout, as designed in the builder, is separately stored as HTML/CSS so that it can easily reference the additional elements to produce the final website. Once the website is designed, the user prepares the storyboard for compliance review by initiating an approval workflow process. More specifically, upon selecting an option to generate a storyboard, the system calls an HTML template for each type of storyboard page and generates the HTML for each selected page. The entire storyboard document is assembled from the individual pages into one single HTML and the final storyboard document is generated in either HTML or PDF format.

The system provides various features that further improve upon current methods of preparing digital content for multidisciplinary review and approval. For example, the HTML or PDF document is interlinked so that users can click to jump to other pages, where there are internal links, or to external websites, where there are external links. There are multiple choices for customization, including whether to add a cover page, a brand logo, version and date, and notes (if added to individual content pages). If a user has optionally integrated this software with an external content review and approval system, such as Veeva Vault in the life sciences industry, a PDF can be automatically generated and transferred into that system via an application programming interface (API) where it creates a new document for formal review and approval. If there are any endnotes (i.e., references, footnotes or abbreviations) built into the content and identified using the application's endnotes library feature, such endnotes would be automatically extracted into the HTML or PDF.

Accordingly, the present invention reduces the overall amount of manual input and quality control needed when creating website content to undergo the review and approval process. In turn, the present invention reduces the risk of error and further reduces the amount time and costs involved.

In one aspect, the present invention is directed to a website creation and management system. The system includes a cloud-based server configured to communicate and exchange data with one or more computing devices over a network, the cloud-based server comprising a hardware processor coupled to non-transitory, computer-readable memory containing instructions executable by the processor to cause the server to provide a digital platform comprising an interface with which a user can interact via an associated computing device for the creation and management of a website.

For example, the system is able to receive a request for a website design, the request including website design session data based on user input with the interface. For example, the user input may include user selection of one of a plurality of types of websites to be created, as well as user-provided content entered via a no-code builder for each webpage of a given selected website. The content includes informational content and/or interactive content selected from the group consisting of text, graphics, images, video, interactive input buttons, interactive input fields, interactive links, webpage and/or website structure, webpage and/or website formatting, and webpage and/or website flow.

The plurality of types of websites include at least an informational-type website and an interactive-type website. An interactive-type website may include interactive content in the form of text associated with a quiz, survey, and/or gamified experience. For example, the interactive content may include user-generated question text, user-generated answer choice text, optionally user-designated correct answers, and optionally a scoring system for user-designated correct answers. The user selection of interactive input buttons, interactive input fields, and/or interactive links trigger associated events comprising at least one of linking to an internal or external webpage and opening a PDF or other media type.

The webpage and/or website structure, the webpage and/or website formatting, and the webpage and/or website flow are associated with at least one of: how individual pages are interlinked; whether an end user navigates manually or automatically through the website; the manner in which an end user navigates based on interaction with a given webpage and elements thereof; appearance of headers and/or footers of a given webpage; whether a menu is present in a given webpage; and links and/or text available in a menu.

In turn, the system is configured to store website design session data, including user-provided content, in a database, wherein individual elements of said user-provided content are separately stored and associated with structure and formatting data of a respective webpage, and structure and formatting data of a website is separately stored and associated with a respective webpage.

During storage of website design session data, the system may be configured to provide the user with an option to add one or more special pages to the website. The one or more special pages comprises a validation page intended for validation of an end user and/or website viewer. For example, in one embodiment, the validation page comprises a default, pre-built template consisting of text and two associated interactive buttons, a first button directing an end user or website viewer to a website intended for a validated end user or website viewer upon selection thereof and a second button directing an end user or website viewer to an alternate website intended for non-validated end user or website viewer upon selection thereof. The validation page may include an access-based inquiry requiring an end user or website viewer to provide input to thereby gain access to a website intended for a validated end user or website viewer. The access-based inquiry may include one or more challenge questions and said input to be provided comprises one or more answers to said one or more challenge questions recognized as valid answers. The access-based inquiry may include a login-based inquiry and said input to be provided comprises a recognized username and/or password.

In some embodiments, the one or more special pages comprises a selectable option allowing for an end user or website viewer to opt-in or register for receipt of communication, including SMS and/or email communication, concerning the content of the website. For an interactive-type website, the one or more special pages comprises a selectable option providing an end user or website viewer with results of an associated survey, quiz, and/or gamified experience, and optionally one or more buttons directing an end user or website viewer to one or more websites.

The system is able to then receive a request for generation of a storyboard document associated with the website design, the request including user selection of one of a plurality of storyboard document generation formats and options for each page of the storyboard document. The storyboard document may be requested so that it can undergo review and approval. The plurality of storyboard document generation formats and options are selected from the group consisting of: user election to include an entire storyboard, in addition to mandatory individual pages, or omission of any storyboard page; user election to include one or more special pages; user election to include one or more hidden pages; user election to include a logo; user election to include a cover page with title and date of document; and user election to include notes to be appended as metadata while building pages or the entire website.

In response to the user request, the system is able to then provide a plurality of individual hypertext markup language (HTML) templates for each page of the storyboard document, each of the HTML templates being populated from said stored website design session data. The plurality of individual HTML templates for each type of page of said storyboard document may be selected from the group consisting of: an individual page template; a menu page template; a special pop-up page template; a storyboard page template; a cover page template; and a special page template. The individual page template comprises multiple elements associated with content and functionality of a given webpage of the website. The multiple elements are selected from the group consisting of: a title of the webpage; a status of a review and/or approval process of the webpage; a preview of a full webpage in HTML display in a mobile window; a logo if selected; description of the functionality of one or more interactive elements; description of any interactive links; categories and intended audiences of content of the webpage; references, footnotes, and/or abbreviations; and notes. For an interactive-type website, the multiple elements comprise descriptions of the one or more interactive elements, including descriptions of questions, answer choices, correct answers, and/or an associated scoring system.

In some embodiments, the storyboard page template is selected from the group consisting of: a board view template; a map view template; and a flow view template. When in a board view template, one or more pages are generated in linear format with pages shown in a left-to-right view based on navigation and titles of each page are presented in a manner to indicate association with each respective page, and, for any page not accessible via main navigation, said pages are shown vertically as sub-pages. When in a map view template, only titles of pages are shown in a top-to-bottom view across multiple pages and sub-pages are shown to the right.

When in a flow view template, one or more pages are generated in a linear format with pages shown in a left-to-right view based on navigation and each page is numbered and titles of each page are shown in a list on a right side of the storyboard, and, for any page not accessible via main navigation, said pages are shown vertically as sub-pages.

The system is then configured to generate, in response to user selection thereof, an HTML for each page of the storyboard document and assemble each page of the storyboard document into a single HTML and subsequently generate a final storyboard document in either HTML format or PDF for subsequent compliance review and approval of content within.

In some embodiments, the system is configured to generate and publish the final storyboard document to a uniform resource locator (URL) to enable compliance review and approval of content within.

In some embodiments, the system is further configured to automatically transmit the final storyboard document for compliance review and approval of content via a third-party compliance review and approval resource. The third-party compliance review and approval resource may include Veeva Vault, for example.

In some embodiments, upon successful compliance review and approval of the final storyboard document, the system is configured to generate and publish a website to a URL.

As previously described, the system further provides for the management of endnotes (i.e., references, footnotes, and abbreviations) to reduce the amount of work and quality control needed in ongoing use of such endnotes across multiple promotional and educational websites.

For example, when designing the website via the system of the present invention, the user-provided content could also include endnotes comprising one or more references, footnotes, and/or abbreviations associated with a respective element provided on a given webpage (the element being text, image(s), or video(s)). The system is configured to automatically link an endnote with a respective element of a webpage. In particular, the system may be configured to dynamically regulate the sequential insertion of numeric characters and/or symbolic characters for a given element and tied to a corresponding reference and/or footnote, respectively.

The system is configured to store endnotes in a dedicated endnote library.

For example, in the case of references, the system is configured to automatically create and store a full citation for a given reference based on a predefined citation format. The predefined citation format may be accordance with at least one of: American Psychological Association (APA) Style, Modern Language Association (MLA) Style, Chicago Style, AMA Style, and Vancouver Style.

It should be noted that the system is configured to receive endnotes either manually via custom input forms provided to the user or an API. For example, the user can input a reference via an API connection to an external database for automatic import of one or more references, wherein the external database may generally be associated with a biomedical and/or life sciences literature database. For example, the external database may be PubMed and the user input comprises at least one of a PubMed Identifier (PMID), a Digital Object Identifier (DOI), a Publisher Item Identifier (PII), or the title of a journal article or book to which the reference is to be associated. The system may be configured to parse retrieved information associated with a given reference, and based on said user input, into said endnote dedicated library.

When a user manually inputs endnotes into the system, the system provides custom input forms, which include a plurality of fields prompting the user to provide corresponding information into each field for a given endnote. It should be noted that a custom input form for a footnote may generally include a first field designated for a title of the footnote and a second field designated for a complete text of the footnote. It should be noted that a custom input form for an abbreviation comprises a first field designated for the abbreviation and a second field designated for a full description of the designation. It should further be noted that a user can input an abbreviation via an API connection to an external database for automatic import of one or more abbreviations, wherein the external database is associated with a biomedical and/or life sciences literature database.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram illustrating one embodiment of an exemplary system for providing the creation, review, approval, publishing, and analytics of website content consistent with the present disclosure.

FIG. 2 is a block diagram illustrating the website creation and management system of FIG. 1 in greater detail.

FIG. 3 is a block diagram illustrating an exemplary computing system for implementing one or more servers for running the website creation and management system consistent with the present disclosure.

FIG. 4 is a block diagram illustrating use of the website creation and management system for the design of website content and automatic generation of a detailed document in HTML or PDF format for the review and approval of content being built based on user interaction therewith.

FIG. 5 is a flow diagram generally illustrating the overall process by which the system of the present invention is configured to design website content, automatically generate a detailed document in HTML or PDF format for the review and approval of content being built, approval workflow management, and eventual no-code publishing of content to a website.

FIGS. 6, 7, 8A, 8B, 9, and 10 are flow diagrams illustrating various steps carried out by the system, including initial website design and content creation (FIGS. 6 and 7), storage of website content (FIGS. 8A and 8B), initiation of approval workflow (FIG. 9), and HTML template and creation (FIGS. 9 and 10).

FIG. 11 shows an exemplary individual page HTML template provided to a user.

FIGS. 12A, 12B, and 12C show exemplary storyboard page HTML templates from which a user can select.

FIG. 13 is a flow diagram illustrating additional steps carried out by the system, including the assembly of an entire storyboard document (assembled from the individual HTML pages into one single HTML) and subsequent generation and display of the final storyboard document in either HTML or PDF format. As a final option, the storyboard can be automatically delivered to a third-party software.

FIG. 14 is a flow diagram generally illustrating the overall process by which the system of the present invention is configured to manage endnotes (i.e., references, footnotes, and abbreviations) during the design of website content, generation of the detailed document in HTML or PDF format for the review and approval of content being built, and subsequent approval workflow management, and eventual no-code publishing of content to a website.

FIGS. 15 and 16 are flow diagrams illustrating various steps carried out by the system for endnote management, including initial endnote creation and addition to website content (FIG. 15) and subsequent endnote storage and incorporation into given pages of an entire storyboard document and subsequent generation and display of the final storyboard document in either HTML or PDF format (FIG. 16).

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present invention is directed to a website creation and management system that provides a complete end-to-end solution for certain high compliance industries. In particular, the website creation and management system provides a no-code, fully integrated web application allowing for the design of website content, automatic generation of a detailed document in HTML or PDF format for the review and approval of content being built, approval workflow management, no-code publishing of content to a website, and analytics of website performance.

The website creation and management system is configured to provide a digital platform comprising an interface with which a user can interact for the creation and management of a website. The user is able to design a website and subsequently generate a detailed document (i.e., storyboard) to undergo a review and approval process (before the website is published) so as to make sure such content provided meets any regulatory standards.

For example, the user may utilize the UI provided via the platform to first determine the type of website that will be built. Once the type of website is decided, the user is able to create/design various types of website content (e.g., text, images, videos, etc.) by entering data in the application using a specific no-code builder. Upon saving individual website content, the system stores the content as data in a proprietary database, where individual elements are separately saved for easy referencing. The layout, as designed in the builder, is separately stored as HTML/CSS so that it can easily reference the additional elements to produce the final website. Once the website is designed, the user prepares the storyboard for compliance review by initiating an approval workflow process. More specifically, upon selecting an option to generate a storyboard, the system calls an HTML template for each type of storyboard page and generates the HTML for each selected page. The entire storyboard document is assembled from the individual pages into one single HTML and the final storyboard document is generated in either HTML or PDF format.

The system provides various features that further improve upon current methods of preparing digital content for multidisciplinary review and approval. For example, the HTML or PDF document is interlinked so that users can click to jump to other pages, where there are internal links, or to external websites, where there are external links. There are multiple choices for customization, including whether to add a cover page, a brand logo, version and date, and notes (if added to individual content pages). If a user has optionally integrated this software with an external content review and approval system, such as Veeva Vault in the life sciences industry, a PDF can be automatically generated and transferred into that system via an API where it creates a new document for formal review and approval. If there are any endnotes (i.e., references, footnotes or abbreviations) built into the content and identified using the application's endnotes library feature, such endnotes would be automatically extracted into the HTML or PDF.

Accordingly, the present invention reduces the overall amount of manual input and quality control needed when creating website content to undergo the review and approval process. In turn, the present invention reduces the risk of error and further reduces the amount time and costs involved.

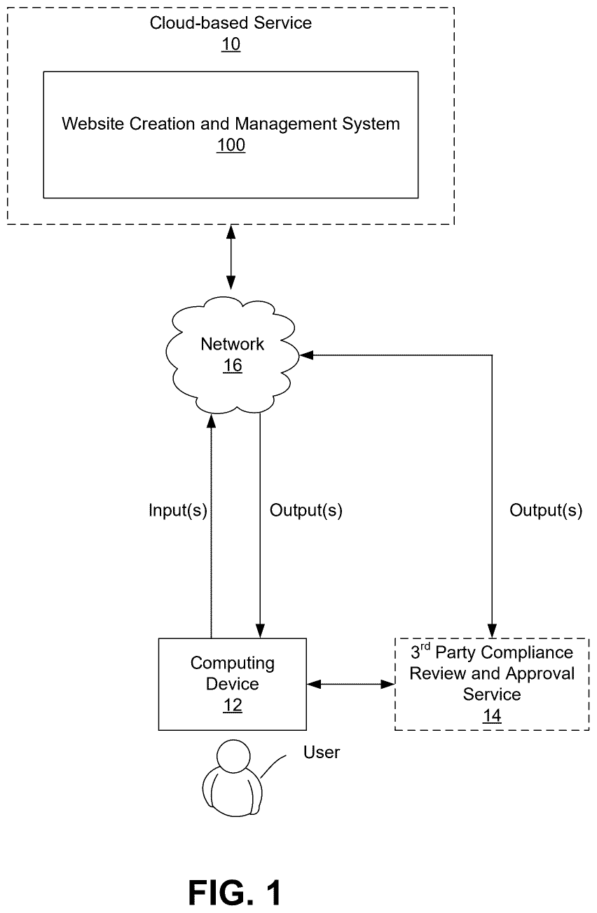

FIG. 1 is a block diagram illustrating one embodiment of an exemplary system for providing the creation, review, approval, publishing, and analytics of website content consistent with the present disclosure.

As shown, the website creation and management system 100 may be embodied on an internet-based computing system/service. For example, as shown, the system 100 may be embodied on a cloud-based service 10, for example. The website creation and management system 100 is configured to communicate and share data with at least a computing device 12 associated with a user. The computing device 12 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure. In the embodiments described here, the computing device 12 is generally embodied as a computer, a desktop computer, a personal computer (PC), a tablet computer, a laptop computer, a notebook computer, and the like.

In some embodiments, the system may also be configured to communicate with a third-party service or software 14 for the compliance review and approval of content, as described in greater detail herein. The system 100 is configured to communicate and exchange data with the computing device 12 (and the third-party service or software 14) over a network 16, for example. The network 16 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the computing device 12 and the system 100 may be, in whole or in part, a wired connection.

The network 16 may be any network that carries data. Non-limiting examples of suitable networks that may be used as network 16 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G), fifth generation (5G), and future generations of cellular-based data communication technologies, Bluetooth radio, Near Field Communication (NFC), the most recently published versions of IEEE 802.11 transmission protocol standards, other networks capable of carrying data, and combinations thereof. In some embodiments, network 16 is chosen from the internet, at least one wireless network, at least one cellular telephone network, and combinations thereof. As such, the network 16 may include any number of additional devices, such as additional computers, routers, and switches, to facilitate communications. In some embodiments, the network 16 may be or include a single network, and in other embodiments the network 16 may be or include a collection of networks.

The system 100 is configured to communicate and share data with computing devices 12 associated with one or more users associated with a life science company. For example, as previously described herein, the system addresses issues currently faced by companies, specifically life science companies, with regard to regulatory standards when creating and disseminating content related to their products and research. For example, the website creation and management system 100 is configured to provide a digital platform comprising an interface with which a user can interact for the creation and management of a website. The user is able to design a website and subsequently generate a detailed document (i.e., storyboard) to undergo review and approval process (before the website is published) so as to make sure such content provided meets any regulatory standards.

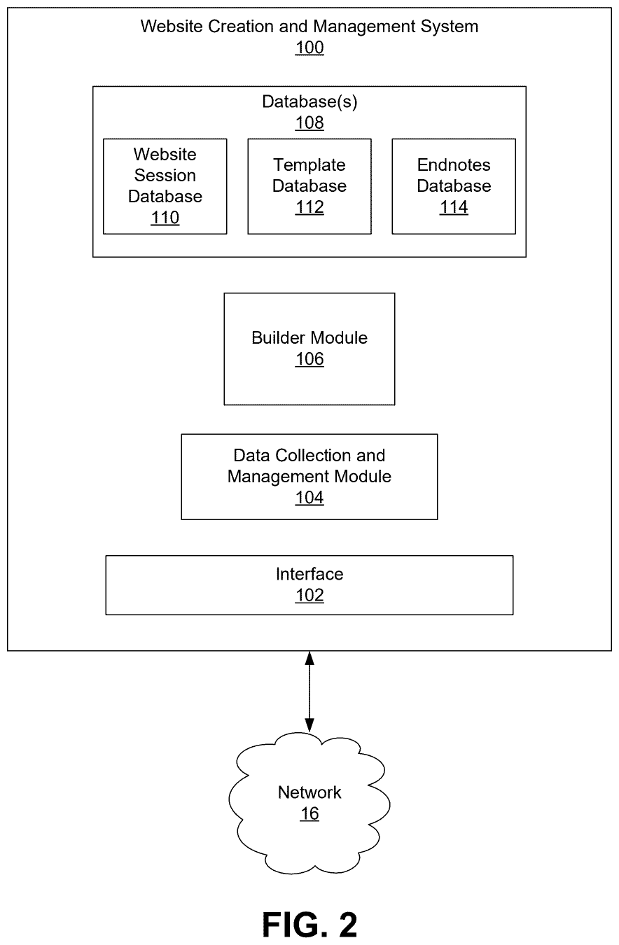

FIG. 2 is a block diagram illustrating the website creation and management system 100 in greater detail, including a no-code builder module 106, for providing a fully integrated web application allowing for the design of website content, automatic generation of a detailed document in HTML or PDF format for the review and approval of content being built, approval workflow management, no-code publishing of content to a website, and analytics of website performance. The system 100 is preferably implemented in a tangible computer system built for implementing the various methods described herein.

As shown, the system 100 may include an interface 102, a data collection and management module 104, a no-code builder module 106, and various databases 108 for storage of data, including, but not limited to, a website session database 110, a template database 112, and an endnotes database 114.

As illustrated, the system 100 may generally be accessed by a user, to initiate methods of the invention, including the initial design of a website, include website content, and subsequently obtain an automatically generated detailed document in HTML or PDF format (i.e., a storyboard document) for the review and approval of content of the website, via an interface 102, for example. The interface 102 allows for a user to connect with a platform provided via the system and initiate website creation/design sessions, specifically allowing for a user to select of one of a plurality of types of websites to be created (via templates provided via the template database 112) and provide content for each webpage of a given website. The content may include, for example, informational content and/or interactive content selected from the group consisting of text, graphics, images, video, interactive input buttons, interactive input fields, interactive links, webpage and/or website structure, webpage and/or website formatting, and webpage and/or website flow.

The system 100 may further include one or more databases 108 with which the data collection and management module 104 and no-code builder module 106 communicate. In the present example, a website session database 110 may include a plurality of profiles for each website created by a user, each profile including various data tied to a given website and each page of a given website, including, but not limited to, the user-provided content (i.e., informational content and/or interactive content selected from the group consisting of text, graphics, images, video, interactive input buttons, interactive input fields, interactive links, webpage and/or website structure, webpage and/or website formatting, and webpage and/or website flow). The template database 112 may generally include stored templates of individual hypertext markup language (HTML) templates for each page of said storyboard document to be generated (i.e., an individual page template, a menu page template, a special pop-up page template, a storyboard page template, a cover page template, a special page template, etc.), from which the user can select, as described in greater detail herein. The endnotes database 114 may generally include one or more references, footnotes, and/or abbreviations associated with a respective element provided on a given webpage of a website, as will be described in greater detail herein.

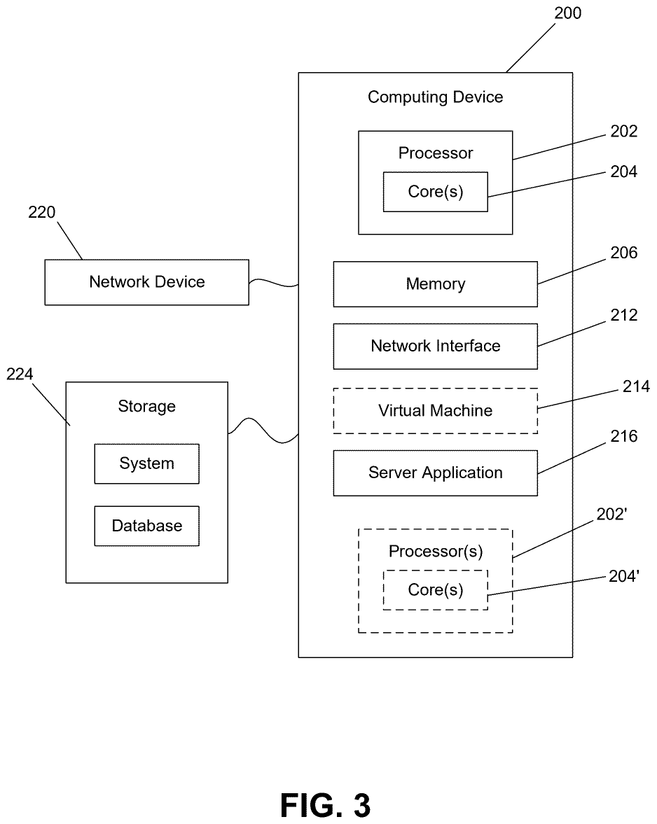

FIG. 3 is a block diagram illustrating an exemplary computing system 200 for implementing one or more servers for running the website creation and management system 100 consistent with the present disclosure. In the present embodiment, the computing system 200 is configured as a server that is programmed and/or configured to execute one of more of the operations and/or functions for embodiments of the system 100 described herein and to facilitate communication with the user devices via the user interface. The computing system 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more solid state drives), and the like. For example, memory 206 included in the computing system 200 can store computer-readable and computer-executable instructions or software for implementing exemplary embodiments of the components/modules of the system 100 or portions thereof. The computing system 200 also includes configurable and/or programmable processor 202 and associated core 204, and optionally, one or more additional configurable and/or programmable processor(s) 202′ (e.g., central processing unit, graphical processing unit, etc.) and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing system 200 so that infrastructure and resources in the computing device may be shared dynamically. One or more virtual machines 214 may be provided to handle a process running on multiple processors so that the process appears to be using only one computing resource rather than multiple computing resources. Multiple virtual machines may also be used with one processor. Memory 206 may include a computer system memory or random access memory, such as DRAM, SRAM, EDO RAM, and the like. Memory 206 may include other types of memory as well, or combinations thereof.

The computing system 200 may include or be operatively coupled to one or more data storage devices 224, such as a hard-drive, CD-ROM, mass storage flash drive, or other computer readable media, for storing data and computer-readable instructions and/or software that can be executed by the processing device 202 to implement exemplary embodiments of the components/modules described herein with reference to the system 100.

The computing system 200 can include a network interface 212 configured to interface via one or more network devices 220 with one or more networks, for example, a Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections (including via cellular base stations), controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing the computing system 200 to any type of network capable of communication and performing the operations described herein. While the system device 200 depicted in block diagram is implemented as a server, exemplary embodiments of the computing system 200 can be any computer system, such as a workstation, desktop computer or other form of computing or telecommunications device that is capable of communication with other devices either by wireless communication or wired communication and that has sufficient processor power and memory capacity to perform the operations described herein.

The computing system 200 may run any server operating system or application 216, such as any of the versions of server applications including any Unix-based server applications, Linux-based server application, any proprietary server applications, or any other server applications capable of running on the computing system 200 and performing the operations described herein.

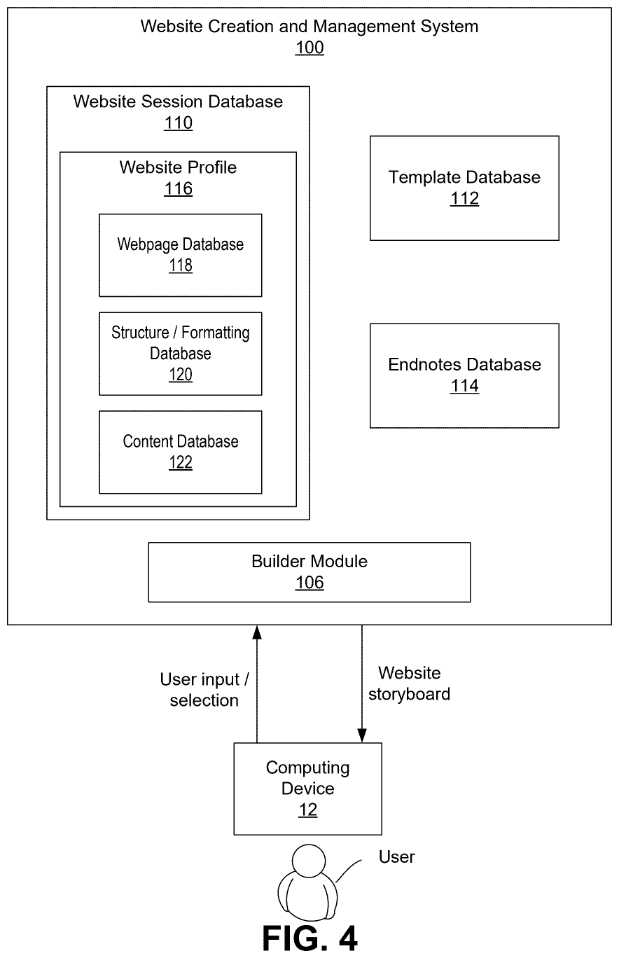

FIG. 4 is a block diagram illustrating use of the website creation and management system 100 for the design of website content and automatic generation of a detailed document in HTML or PDF format for the review and approval of content being built based on user interaction therewith. As previously described, the system 100 provides a digital platform comprising an interface with which a user can interact via an associated computing device 12 for the creation and management of a website.

A user can interact with the interface and initiate a website design session, the request including website design session data based on user input with the interface. The website design session data is stored within the website session database 110, namely within a respective website profile 116. The user input includes user selection of one of a plurality of types of websites to be created (which could include an informational-type website and an interactive-type website). The user input further includes user-provided content entered, via the no-code builder module 106, for each of webpage of a given selected website profile. As previously described, the user-provided content may include informational content and/or interactive content which may include, but is not limited to, text, graphics, images, video, interactive input buttons, interactive input fields, interactive links, webpage and/or website structure, webpage and/or website formatting, and webpage and/or website flow. The user-provided content may further include endnotes comprising one or more references, footnotes, and/or abbreviations associated with a respective element provided on a given webpage, said element comprising text, an image, or a video. Such endnotes data may be separately stored in a respective database (database 114). As will be described in greater detail herein, the system is configured to automatically link an endnote with a respective element of a webpage, including dynamically regulating the sequential insertion of numeric characters and/or symbolic characters for a given element and tied to a corresponding reference and/or footnote, respectively.

In turn, the system 100 stores website design session data, including user-provided content, in respective databases, wherein individual elements of said user-provided content are separately stored (stored in database 122) and associated with structure and formatting data of a respective webpage, and wherein structure and formatting data of a website is separately stored (stored in database 120) and associated with a respective webpage (each webpage being stored in database 118).

Upon designing a website, including one or more webpages, the user may then initiate a request for generation of a storyboard document associated with the website design, the request including user selection of one of a plurality of storyboard document generation formats and options for each page of the storyboard document. In turn, the system 100 provides a plurality of individual hypertext markup language (HTML) templates for each page of said storyboard document, each of the HTML templates being populated from said stored website design session data. As previously described, the templates may be stored in a respective database (i.e., database 112).

The HTML templates may include, but are not limited to, an individual page template, a menu page template, a special pop-up page template, a storyboard page template, a cover page template, and a special page template.

For example, an individual page template may include multiple elements associated with content and functionality of a given webpage of the website. The multiple elements may include, but are not limited to, a title of the webpage, a status of a review and/or approval process of the webpage, a preview of a full webpage in HTML display in a mobile window, a logo if selected, description of the functionality of one or more interactive elements, description of any interactive links, categories and intended audiences of content of the webpage, references, footnotes, and/or abbreviations, and notes. For example, for an interactive-type website, the multiple elements may include descriptions of the one or more interactive elements, including descriptions of questions, answer choices, correct answers, and/or an associated scoring system.

A storyboard page template may include, for example, a board view template, a map view template, and a flow view template. By way of example, when in a board view template, one or more pages may be generated in linear format with pages shown in a left-to-right view based on navigation and titles of each page are presented in a manner to indicate association with each respective page, and, for any page not accessible via main navigation, said pages are shown vertically as sub-pages. By way of example, when in a map view template, only titles of pages may be shown in a top-to-bottom view across multiple pages and sub-pages are shown to the right. By way of example, when in a flow view template, one or more pages are generated in a linear format with pages shown in a left-to-right view based on navigation and each page is numbered and titles of each page are shown in a list on a right side of the storyboard, and, for any page no accessible via main navigation, said pages are shown vertically as sub-pages.

Upon the user selecting one of a plurality of storyboard document generation formats and options for each page of the storyboard document system, the system 100 generates an HTML for each page of said storyboard document and assembles each page of the storyboard document into a single HTML. Subsequently, the system 100 is able to generate a final storyboard document in either HTML format or portable document format (PDF) for subsequent compliance review and approval of content.

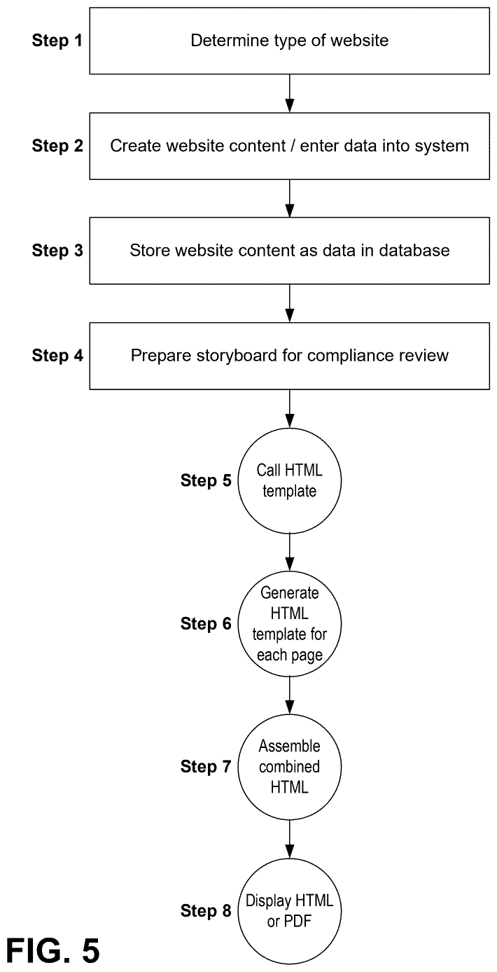

FIG. 5 is a flow diagram generally illustrating the overall process by which the system 100 of the present invention is configured to design website content, automatically generate a detailed document in HTML or PDF format for the review and approval of content being built, approval workflow management, and eventual no-code publishing of content to a website. The user of the application first determines the type of website that will be built (step 1). The different types of websites envisioned in the application are described further in a subsequent figure. Once the type of website is decided, the user creates various types of website content e.g., text, images, videos, by entering data in the application using a specific no-code builder module (step 2). Upon saving individual website content, the system stores the content as data in proprietary database(s) (step 3), where individual elements are separately saved for easy referencing. The layout as designed in the builder is separately stored as HTML/CSS so that it can easily reference the additional elements to produce the final website. Once the website is designed, the user prepares the storyboard for compliance review (step 4) by initiating an approval workflow. Upon selecting the option to generate a storyboard, the application calls an HTML template for each type of storyboard page (step 5) and generates the HTML for each selected page (step 6). The entire storyboard document is assembled from the individual pages into one single HTML (step 7) and the final storyboard document is generated in either HTML or PDF format (step 8).

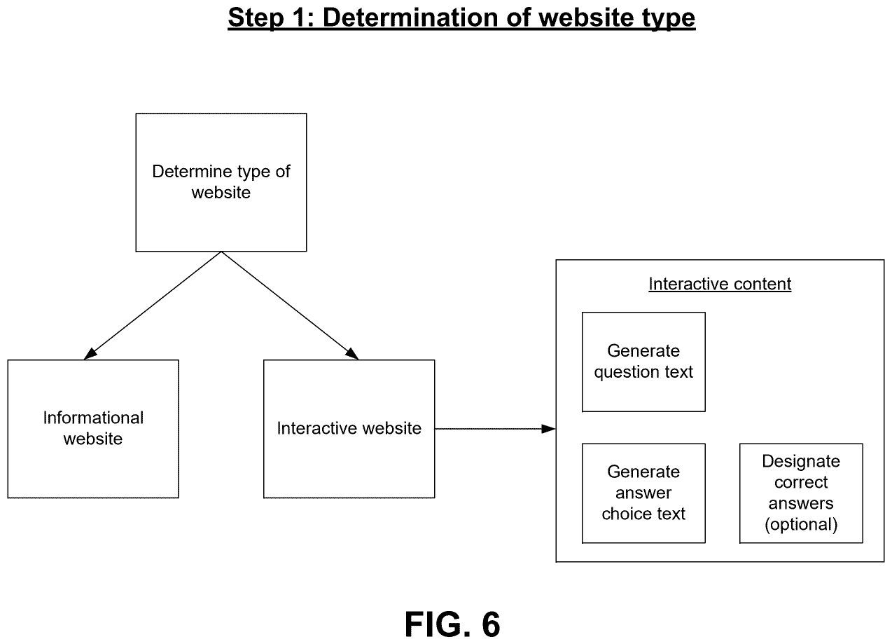

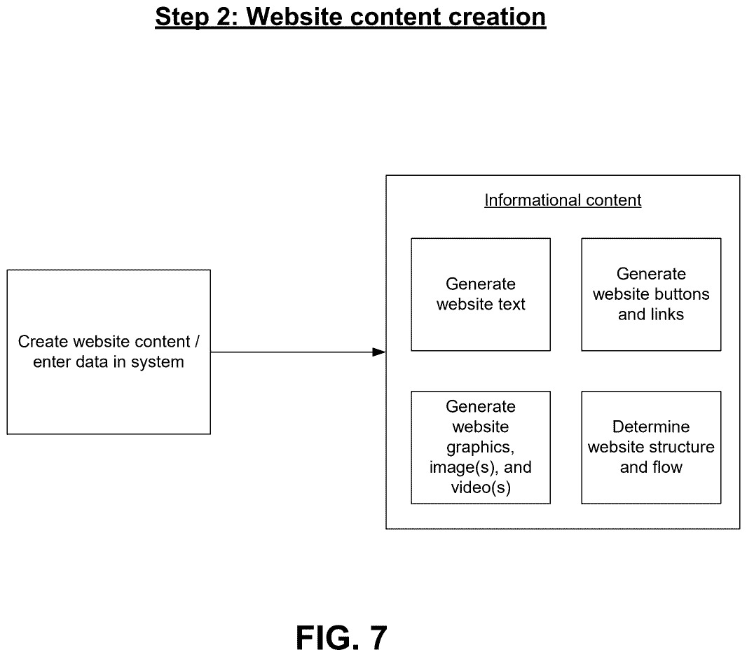

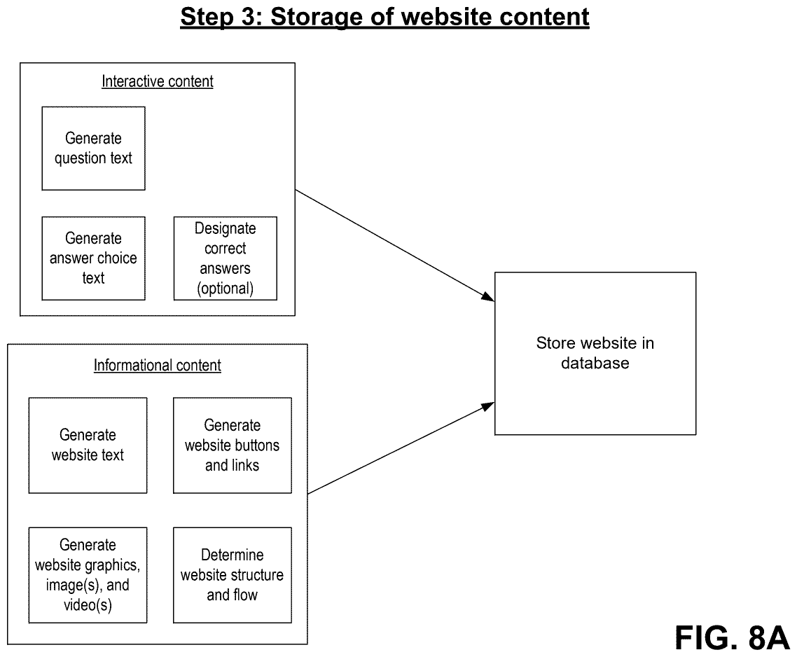

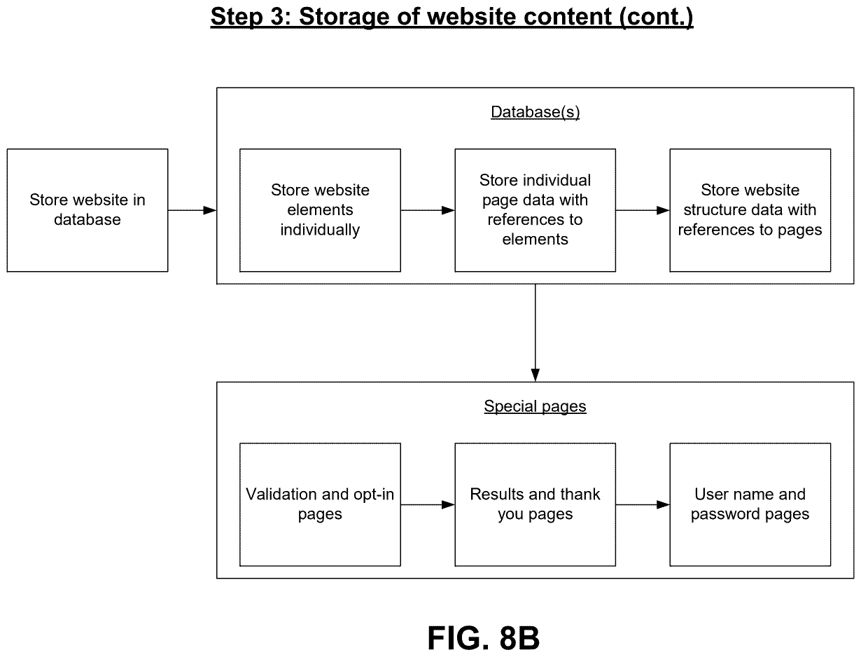

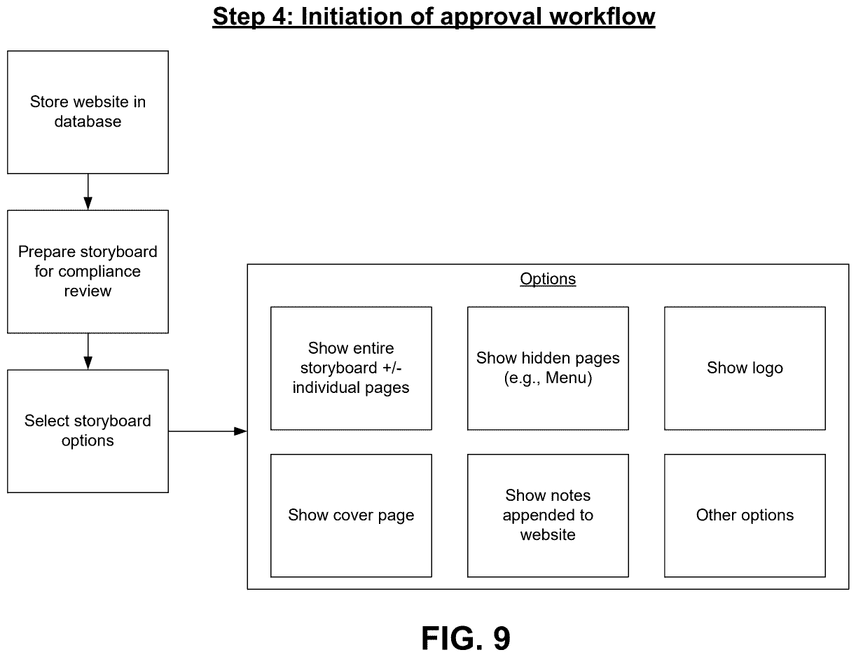

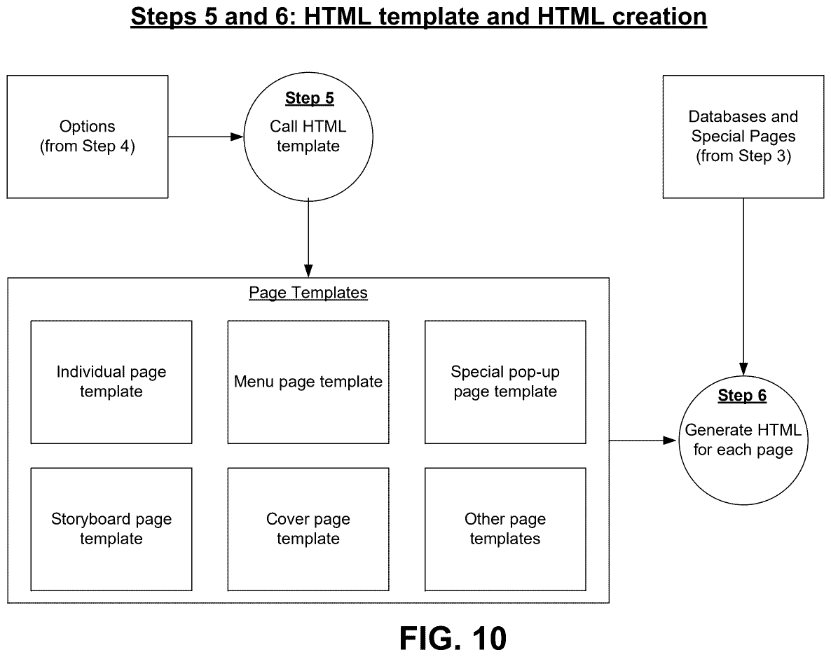

FIGS. 6, 7, 8A, 8B, 9, and 10 are flow diagrams illustrating various steps carried out by the system, including initial website design and content creation (FIGS. 6 and 7), storage of website content (FIGS. 8A and 8B), initiation of approval workflow (FIG. 9), and HTML template and creation (FIGS. 9 and 10).

In the first step (FIG. 6), the user of the application first determines the type of website that will be built. At a high level, there are two types of websites envisioned in this application: those intended to be largely informational (i.e., standard promotional or educational websites) and those intended to be largely interactive (i.e., quiz or gamified website, survey or market research website). For websites that are envisioned to be interactive, interactive content should be determined prior to website design. For example, a user should generate question text, answer choice text, and optionally designate correct answers in case of a quiz or gamified experience. Multiple types of questions and answers are envisioned, including those with a single answer possible (e.g., A), those with multiple answers possible (e.g., A and B), those with a free text entry field, those with a number or percentage entry field, those that require reordering a list of responses into a particular list or order.

In the second step (FIG. 7), the user creates various types of website content by entering data in the application using the no-code builder module. Informational content can take many forms in the application, including, but not limited to, text, graphics, images, and videos in various formats (e.g., including but not limited to: SVG or CSS for graphics; PNG, JPG, SVG, WEBP, GIF, BMP for images; and MP4 or MOV for videos), interactive buttons and links, which trigger associated events (e.g., including, but not limited to, linking to an internal or external web page, opening a PDF, opening another media type), and website structure and flow (e.g., the manner in which individual pages are interlinked, whether a user navigates manually or automatically, whether a user navigates by swiping left/right or clicking on buttons, how headers and footers appear, whether there is a menu and what links or text are available in the menu, among other content).

In the third step (FIGS. 8A and 8B), the system stores the interactive content and informational content as data in proprietary database(s), where individual elements are separately saved for easy referencing. Likewise, data for the structure and formatting of each individual web page is stored separately with references to the individual element data and data for the structure and formatting of each website is stored separately with references to the individual web pages.

During the process of saving data, the user is also presented with options to add one or more special pages to the website. This may include a page intended for validation of an end user or website viewer. In the life science industry, a significant amount of content is intended for healthcare professionals and there may be different regulations across jurisdictions. Here, we propose a system by which users creating a website can determine with a single click whether such an optional validation page is needed and, if needed, to edit the default language. There are several options with a validation page. In the simplest form, a user could add a pre-built validation page with some text and two buttons, one of which leads to the intended website and one of which leads to an alternate website for non-validated viewers. In other forms, the validation page could have a drop-down list of options, some of which allow access to the intended website and some of which lead to one or more alternate websites for non-validated viewers. In yet another embodiment, the validation page could have a ‘challenge’ question, allowing access to only validated viewers. Such a validation page is critical for regulatory compliance and for the review and approval of most web content in the life science industry.

A special page might include a page intended for allowing an end user or website viewer to opt-in or register for continued communication (e.g., via SMS or email). In many geographies, opting-in to receiving communications is required from regulatory bodies. Hence, such a feature could be valuable for building out a customer relationship management (CRM) system or enabling communication with customers already in a CRM system. Here, we propose a system by which users creating a website can determine with a single click whether such an optional opt-in page is needed, at the front or back of the intended website. In the simplest form, a user could add a pre-built opt-in page, with a simple form allowing an end user or website viewer to enter a phone number, receive a 6-digit verification code, enter the verification code, and opt-in to receiving future communications via SMS. A similar opt-in can be enabled for email communications.

A special page might include a page intended to display the results of a quiz or gamified experience website (e.g., a score, or a leaderboard) or a pre-built thank you page for respondents on a survey website. Here, we propose a system by which users creating an interactive-type website can determine with a single click whether such an optional results or thank you page is needed and, if needed, to edit the default language. In the simplest form for a results page, a user could add a pre-built results page with the score, while in more advanced forms, the page could show all responses and indicate whether the responses were correct or incorrect, and for incorrect responses show correct answers. In the simplest form for a thank you page, a user could add a pre-built page with some text thanking the respondent and providing a button to direct the user to a subsequent web page.

In some embodiments, a special page might include a page intended for even more stringent verification using a username and/or password. Here, we propose a system by which users creating a website can determine with a single click whether such an optional page is needed and, if needed, to edit the default language, determine whether a username and password are both needed or just a password, and to set a password that would grant access to the website.

It should be noted that all special pages described herein may be created in a modular fashion allowing easy one-click addition into the database and referencing by the storyboard generation system described in greater detail herein.

In the fourth step (FIG. 9), once the website is designed, the user prepares the storyboard for compliance review by initiating the approval workflow process. The approval workflow process starts with selection of various options for the storyboard document. There are multiple options that are possible, each enhancing the experience of the compliance review and approval. For example, the user is asked whether to include the entire storyboard (in addition to the mandatory individual pages) and if so in which format. There may be multiple layout options available, as described greater detail herein. The user can elect to include one of these or to omit an overall storyboard page. Next, the user is asked whether to include special hidden pages, such as those envisioned in the previous sections, or additional ones like an open menu page, an expanded footer pop-up, and so on. The user can elect to include a logo and a cover page with the title and date of the document. Additionally, the user can elect to include notes that can be appended as meta-data while building pages or the entire website and other options.

Upon selecting the option to generate a storyboard, the application calls an HTML template for each type of storyboard page and generates the HTML for each selected page (see steps 5 and 6 shown in FIG. 10.

In the present invention, individual HTML templates for each type of page in the storyboard document have been developed, which include, for example, individual page templates (how one single web page is described for compliance review), a menu page template (how an open menu page is described), a special pop-up page template (how a special pop-up page, e.g., one accessible from a special expand-collapse section in the footer, is described), a storyboard page template (how the overall storyboard is described, depending on the type of storyboard page selected), a cover page template, and other page templates (how a special page is described). Each of the HTML templates is populated from content stored in the database to create individual storyboard pages in HTML.

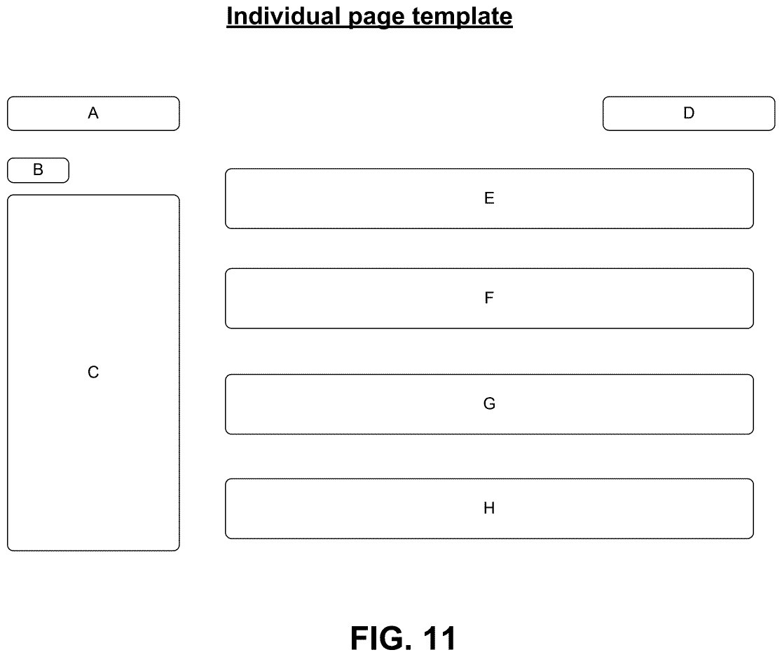

FIG. 11 shows an exemplary individual page HTML template provided to a user. The individual page HTML template may be the most used template. For example, for a website of 20 pages, it is likely that the storyboard document would contain about 25 total pages, of which 20 would be based off this template. Each page will have its own template with multiple elements to describe all content and all functionality, allowing for seamless compliance review and approval.

The elements provided on an individual page HTML template may include, for example:
A. Title. This is stored in the meta-data of the page.
B. Status. This is stored in the meta-data of the page. In our modular application, individual pages can be reused in multiple websites for the easy creation of many website variations. If a web page has been previously reviewed and approved in another website, its status is shown in this website storyboard for easier review and approval. The various statuses in our application include Draft, In Approval, Approved, Published and Retired.
C. Preview. This is a preview of the full web page in HTML, displayed in a mobile window.
D. (Optional) Logo. If selected.
E. Interactive Elements. A variety of interactive elements have been described in this document. The functionality of each element is automatically included here. If a Menu icon is included, an automatic statement is included to explain that clicking it will open a menu page. If Swiping is activated as a navigation option, an automatic statement is included to explain that swiping left/right changes the page. If an Expand-Collapse Footer Section is included, an automatic statement is included to explain that clicking this element expands and collapses a special element with hidden content. If a Footer is included with links, an automatic statement is included to explain links that open a page, website, PDF, or other media. If Links are included in the text, an automatic statement is included to explain links that open a page, website, PDF, or other media. If Buttons are included, an automatic statement is included to explain whether each button opens a page, website, PDF, or other media. If there are Questions and Answers for an interactive-type website, automatic statements are included to explain the functionality, whether one or more choices can be selected, what the limitations are for typed answers, and which answers might be correct or incorrect, if appropriate.
F. Categories and Audiences. This is stored in the meta-data of the page. The categories for each page and the intended audiences are shown automatically. This is important for compliance review because content that is intended for healthcare professionals is treated differently from content intended for consumers, patients, or other audiences.
G. References, Footnotes and Abbreviations. This is stored in the website content. Such information is critical to the review of content in the life sciences. All content intended for healthcare professionals and certain other audiences must contain appropriate references (e.g., from scientific literature), footnotes (e.g., explaining important details such as study design or statistical information), and abbreviations (e.g., if used in the text). Some of this information might be accessible on a click and not shown immediately in the Preview (part C above). As a result, automatically being able to list all that information on the page, next to the Preview, is critical for proper review and approval.
H. Notes. Special notes can be attached to the entire website or to individual pages. In the case of pages, this is stored in the meta-data of the page. These notes are extracted here automatically for additional information that could be relevant to reviewers and approvers.

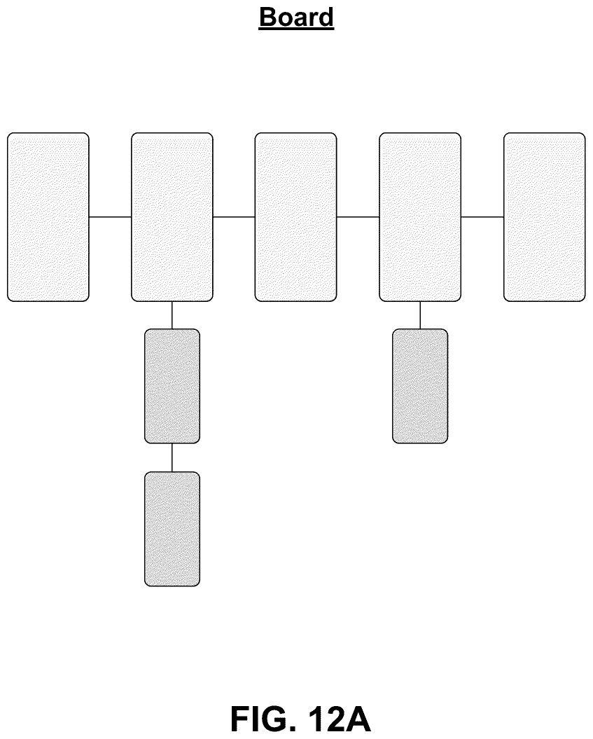

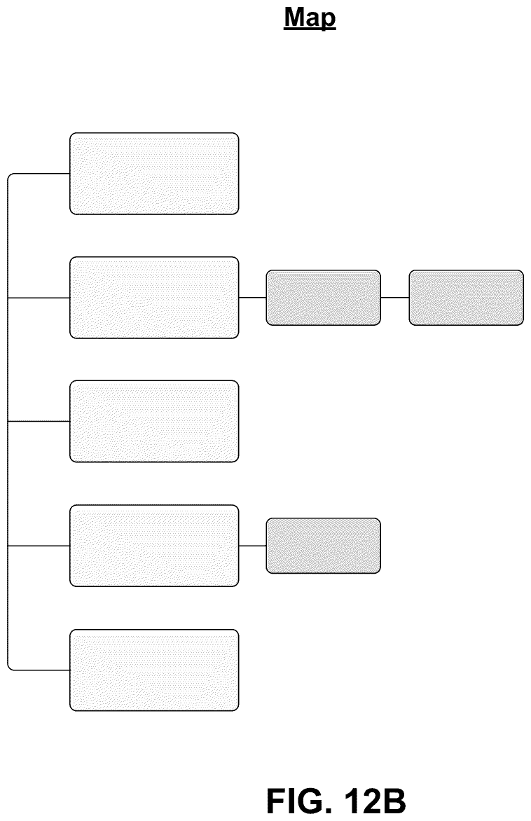

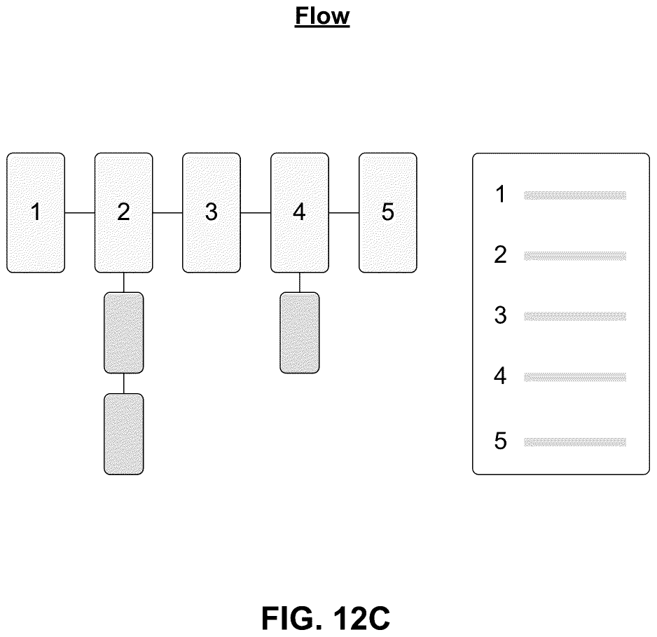

FIGS. 12A, 12B, and 12C show exemplary storyboard page HTML templates from which a user can select. As shown, there are three storyboard page HTML templates. If the user selects the Board (see FIG. 12A), one or more storyboard pages will be generated in a largely linear format, with pages (content shown proportionally in a smaller screen preview) shown left to right based on navigation. The titles of each page are shown underneath the respective page. If there are pages that are not in the main navigation (e.g., not accessible by swiping left/right) but only accessible via buttons, they would be shown vertically as sub-pages. In the Map view (see FIG. 12B), only the titles of pages are shown top to bottom across multiple storyboard pages, with sub-pages shown to the right as appropriate. Finally, in the Flow view (see FIG. 12C), one or more storyboard pages will be generated in a largely linear format, with pages (content shown proportionally in a smaller screen preview) shown left to right based on navigation. Each page is numbered, and the titles of each page are shown in a list to the right of the storyboard. If there are pages that are not in the main navigation (e.g., not accessible by swiping left/right) but only accessible via buttons, they would be shown vertically as sub-pages.

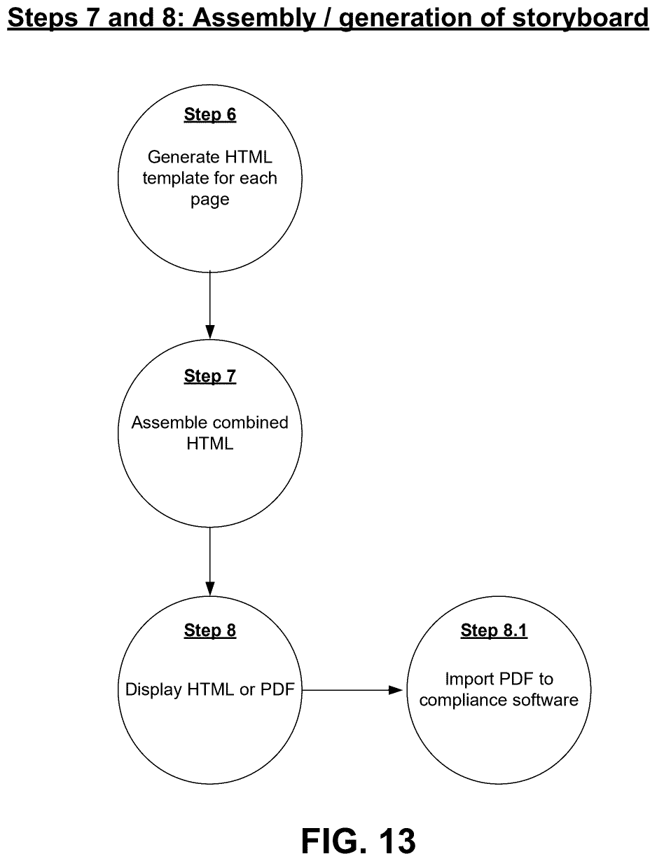

FIG. 13 is a flow diagram illustrating additional steps carried out by the system, including the assembly of an entire storyboard document (assembled from the individual HTML pages into one single HTML) and subsequent generation and display of the final storyboard document in either HTML or PDF format. As a final option, the storyboard can be automatically delivered to a third-party software.

The entire storyboard document is assembled from the individual pages into one single HTML (step 7) and the final storyboard document is generated in either HTML or PDF format (step 8). As a final option, the storyboard can be automatically delivered to a third-party software via API link, if integrated. For example, many life science companies leverage a software called Veeva Vault for the compliance review and approval of content. The system 100 can be linked to Veeva Vault via an API connection, allowing the user to generate the storyboard document, save it as a PDF, and send it to Veeva Vault all in one action. The review and approval of the content can then take place in this external software.

As previously described, the system 100 further provides for the management of endnotes (i.e., references, footnotes, and abbreviations) to reduce the amount of work and quality control needed in ongoing use of such endnotes across multiple promotional and educational websites.

For example, when designing the website via the system of the present invention, the user-provided content could also include endnotes comprising one or more references, footnotes, and/or abbreviations associated with a respective element provided on a given webpage (the element being text, image(s), or video(s).

For example, as previously described, the system may generally include a library/database where endnotes are initially stored. There are separate sections and forms for references, footnotes and abbreviations. Many types of references can be entered: journal article(s), book(s), conference proceeding(s), website(s), prescribing information, summary of product characteristics, data on file, and other references. In the present invention, custom entry forms have been developed for each of these reference types, according to well-known industry standards, including MLA format where relevant. The system allows for the user to view and edit or delete such entries. Furthermore, journal articles and books can be (optionally) automatically imported from PubMed via API by using a PMID, DOI, PII, or Title. In this case, they are correctly formatted according to MLA format or another standard citation format. The no-code builder module is used to apply endnotes content, whereby users create website content and can apply a given endnote (reference, footnote, or abbreviation) to a content in the webpage. The user is able to quickly search the endnote library/database or add new endnotes on the spot (which will also be stored in the library/database). Adding endnotes creates a ‘link’ between the website element and endnote. Numbers (in the case of references) or symbols (footnotes) are automatically inserted and regulated dynamically. The first reference receives a number 1, the second one a number 2, and so on. The first footnote receives an * symbol, the second receives a 1, and so on. These ‘added’ Endnotes can all be seen in a special panel on the webpage builder, where they can be managed.

When an element with an endnote is used in a website that is published, all endnotes automatically appear in an endnote section in a pop-up menu, with the correct numbers and symbols. If there are ever changes needed to an endnote (e.g., to correct an error), a single change in the library/database will automatically update all draft or live websites using this endnote.

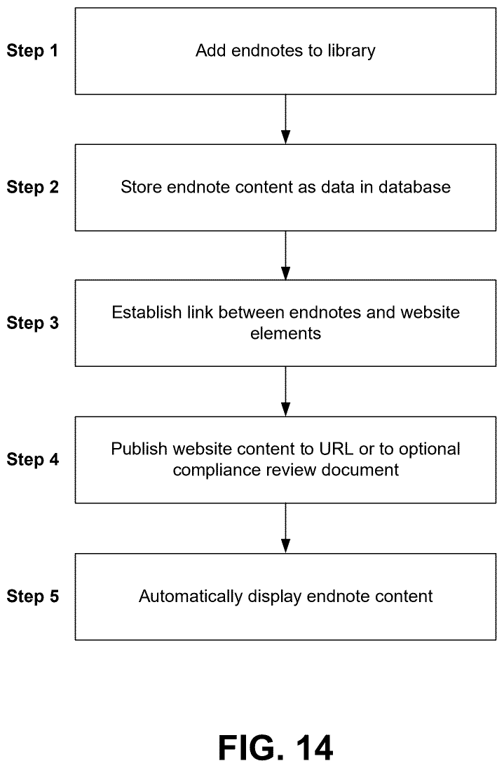

The process for the creation and management of endnotes via the system has five key steps. FIG. 14 is a flow diagram generally illustrating the overall process by which the system of the present invention is configured to manage endnotes (i.e., references, footnotes, and abbreviations) during the design of website content, generation of the detailed document in HTML or PDF format for the review and approval of content being built, and subsequent approval workflow management, and eventual no-code publishing of content to a website.

The user of the application first adds endnotes in a library/database within the system (step 1). Upon saving individual endnote content, the system stores the content as data in a proprietary database, where individual elements are separately saved for easy referencing and consistent citation building (step 2) (as previously described herein). Once the endnotes are created, the user creates various types of website content e.g., text, images, videos, by entering data in the application using the no-code builder module and establishes links between website content and individual endnotes (step 3). The website can be published to a URL or to an optional compliance review document in HTML or PDF format (step 4). If endnotes are linked to content displayed in the final HTML, endnotes are assembled and introduced into the final HTML based on a predefined HTML template for automatic display (step 5).

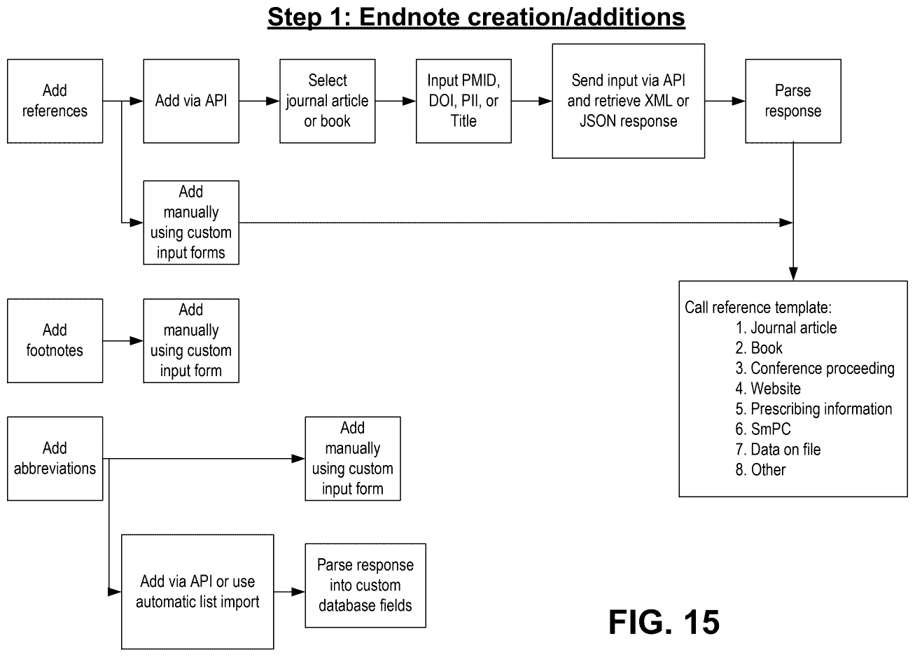

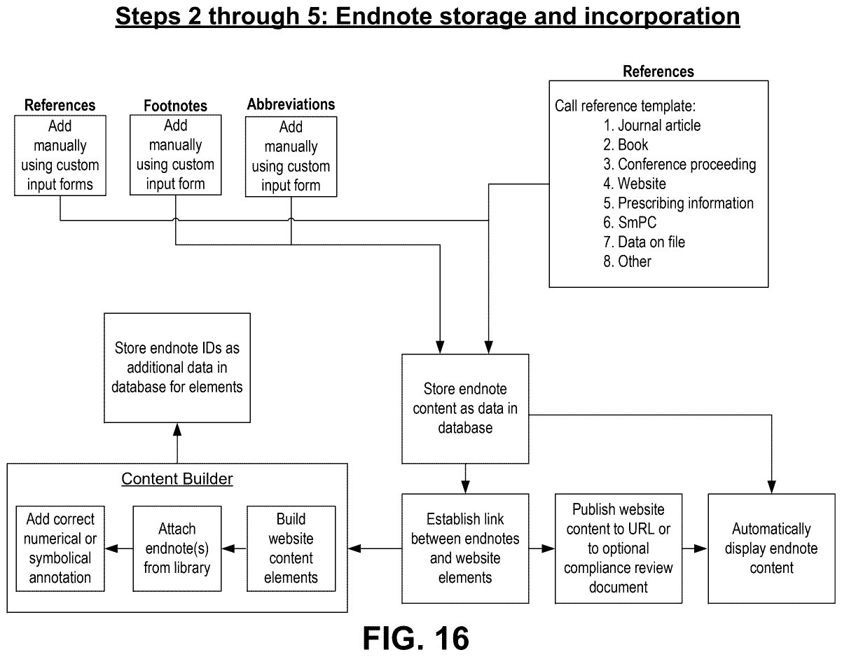

FIGS. 15 and 16 are flow diagrams illustrating various steps carried out by the system for endnote management, including initial endnote creation and addition to website content (FIG. 15) and subsequent endnote storage and incorporation into given pages of an entire storyboard document and subsequent generation and display of the final storyboard document in either HTML or PDF format (FIG. 16).

Referring to FIG. 15, in the first step, the user of the application adds endnotes in a library/database within the system (see FIG. 15). There are three types of endnotes possible in the system: references, footnotes, and abbreviations.

As generally understood, references provide the source of the information, ensuring that the content is credible and backed by scientific research. References are essential for verifying facts, supporting claims about the efficacy, safety, intended use, or mechanism of action of a drug, biologic treatment, medical device, diagnostic or other life science product, and for maintaining transparency. Footnotes are used to give additional context, clarify complex information, or provide information without interrupting the flow of the main text. In medical documents, footnotes can explain statistical methods, the significance of study results, or any assumptions made in the analysis. Finally, medical content often includes a plethora of technical terms which can be lengthy and complex. Abbreviations help in simplifying these terms, making the documents easier to read and quicker to reference.

There are several types of references, and they can be added via an API or manually using custom input forms created in the application. For example, certain types of references (e.g., journal articles and books) can be added using either method. Other types of general and industry-specific references (e.g., conference proceedings, websites, prescribing information, summary of product characteristics (SmPC), data on file, and other references) should be added manually.

For journal articles or books, an API connection could be made to one or more external databases for automatic import of References. For example, in the life science industry, PubMed is a free, online database of biomedical and life sciences literature maintained by the United States National Library of Medicine (NLM) at the National Institutes of Health (NIH). It provides access to millions of citations and abstracts from a wide range of sources, including MEDLINE, life science journals, and online books. The PubMed API, also known as the Entrez Programming Utilities (E-utilities), allows users to access PubMed's vast database of biomedical literature.

As previously described, in the system 100 of the present invention, a user can enter a PMID (a PubMed Identifier), a DOI (a Digital Object Identifier), a PII (Publisher Item Identifier) or the title of a journal article or book, each of which can be sent through the PubMed API to retrieve an XML or JSON response with an array of information about the matched journal article or book. The information retrieved from the PubMed API can be quite extensive, including various data fields associated with scientific publications: Title, Authors, Journal, Publication Date, Abstract, Full Text Links, MeSH Terms, Publication Types, Grant Support, Volume and Issue, Pagination, Identification Numbers (e.g., PMID, DOI, PII), Keywords, Chemical Substances, References, Cited By, Author Affiliations, Corresponding Author, Language, Country of Publication, and more. Other APIs to similar databases may yield similar or different data. The system is set up to parse such retrieved information into a database where each field is separately stored.

For all other reference types, and optionally for journal articles and books, custom input forms are made for manual entry. Some of these forms, for example those for journal articles may have upwards of 20 possible fields, whereas those for other reference types such as prescribing information may only have 3 or 4 possible fields. Whether references are imported into the library/database via API or manually, the information is parsed into separate fields and stored in a common database using templates that are custom built for each type of reference: journal article(s), book(s), conference proceeding(s), website(s), prescribing information, summary of product characteristics, data on file, and other references. As a final step in the storage process, a full citation is automatically created by the system and stored in the database for each reference. The format of the citation can be customized based on predefined templates for commonly used citation styles, for example APA (American Psychological Association) Style, MLA (Modern Language Association) Style, Chicago Style, AMA Style, Vancouver Style, and others.

For footnotes, the process is simpler, in that there is a custom input form that allows text input in two fields: in one field, the title of the footnote, and in the other field, the complete text of the footnote. This is likewise stored in a database like the reference data. For abbreviations, similarly, there is a two-field input form for the abbreviation (e.g., AMA) and the description (e.g., American Medical Association). The system may have direct links via API to external databases or the ability to automatically import a CSV/XLS list of abbreviations (e.g., the FDA Acronyms and Abbreviations database). In either case, the data for abbreviations would be parsed into a database to store the abbreviation and definition fields separately.

The remaining steps (steps 2 through 5) are illustrated in FIG. 16. As described in the previous step, the data for each type of endnote, whether imported automatically or using one of the manual input forms, is stored in a database, with each field stored separately and the entire citation assembled using a specific citation style. A link is established between website elements and one or more endnotes.

Websites can be designed using a variety of programs, some of which require custom coding and some which produce websites in a no-code environment. Depending on the software used, certain elements (sometimes referred to as modules, blocks, or components) can be stored as distinct entities. For example, a block of text might be saved as a separate element; an image might be saved as a separate element; a block of text and an image together might be saved as a separate element. In any of these instances, the limitation with all current software is that users need to preemptively plan Endnotes, added their own symbols to reflect those endnotes, and then add separate elements to define such endnotes (e.g., a Bibliography section at the bottom of a website). Furthermore, any changes need to be manually managed.

In the present invention, the no-code application allows users to build elements and to establish a link between those elements and individual endnotes (step 3). Users first design elements, which can be saved independently (for reuse in multiple web pages) or saved as part of a web page design. Users then select a specific element (e.g., a text block) and use a custom-built feature to select one or more endnotes from the library/database (endnotes database) that are related to or support the content of that element. Users attach the endnotes to that element as meta-data on a single click. Attached endnotes may be reviewed, edited, or deleted. Attached endnotes are automatically connected and indicated via numerical or symbolical annotation.

For example, it is commonplace to use numerical annotations (superscripts) to signify references (e.g., 1,2,3). In the present invention, the system automatically generates the appropriate numerical annotation and places it where appropriate on a web page. For example, the first use of a reference receives a 1, the second receives a 2, and so on. Furthermore, the system is able to detect if the same reference is utilized twice on the same web page, so that there is no repetition. Likewise, if the order of references changes on a web page, e.g., due to rearrangement of individual elements, the system recognizes this and reorders the numerical annotations as well.

In the case of footnotes, it is commonplace to use symbolical annotations, for example standard symbols may include an asterisk (*), dagger (†), double dagger (‡), section sign (§) , number sign (#), and paragraph sign (¶), among others. In the present invention, the system automatically generates the appropriate symbolical annotation and places it where appropriate on a web page. For example, the first use of a footnote receives a *, the second receives a †, and so on. Furthermore, the system is able to detect if the same footnote is utilized twice on the same web page, so that there is no repetition. Likewise, if the order of footnotes changes on a web page, e.g., due to rearrangement of individual elements, the system recognizes this and reorders the symbolical annotations as well.

In the case of abbreviations, there are no annotations added to the content. A link is established, and the system knows that an abbreviation is used in the content and the abbreviations must be defined on the web page using the information stored in the library/database for that abbreviation.

In each case, when the website content is stored in a database, there is additional meta data stored that indicates each endnote linked to each element, and the order of each endnote, so that this information can be subsequently retrieved when the HTML is being assembled.

When the website content is finally published (step 4), whether to a URL for public distribution, or as a private HTML or PDF for optional compliance review, custom HTML templates are automatically populated with endnote content. For example, in one HTML template, endnotes might be placed in a page accessible by clicking a menu icon. In another example, endnotes might be accessible on a pop-up page accessible by clicking a button or other link. In yet another example, endnotes might be accessible using a section that can be expanded or collapsed on click. In any case, endnotes would appear in distinct sections marked references, footnotes, and abbreviations, as relevant for each web page. Only endnotes linked to elements appearing on a web page would be reproduced and such content would be automatically extracted from the database and displayed (step 5) in the correct order and format as described above. Furthermore, abbreviations would be displayed in descending alphabetical order regardless of how they were linked to a web page. For example:

### References

1. LastName, XY, et al. (2000) Article Title. Journal, Volume (Issue): 1-10.

### Footnotes

* Footnote Text.

### Abbreviations

AMA: American Medical Association.

If such endnotes are reused and published in hundreds of web pages simultaneously, a change to correct an error or to reflect an update (with appropriate notification/warning to the user) can be made once in the library/database and such a change would carry through to all web pages. This is in contrast to the extensive manual labor needed for current processes. This is quite valuable in industries such as the life sciences where some references might change frequently. For example, in material (e.g., multiple promotional and educational websites) for a pharmaceutical product, a company might utilize a prescribing information or summary of product characteristics (SmPC) regulatory reference that may change twice a year due to regulatory updates (e.g., Brand®, Company Name, Country, January 2024; Brand®, Company Name, Country, July 2024, etc.). As such, in the present invention, a single 1-minute process would result in immediate changes to hundreds of published references.

As used in any embodiment herein, the term “module” may refer to software, firmware and/or circuitry configured to perform any of the aforementioned operations. “Software” may be embodied as a software package, code, instructions, instruction sets and/or data recorded on non-transitory computer readable storage medium. “Firmware” may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location.

The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions.

Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION OF REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A website creation and management system comprising:
a cloud-based server configured to communicate and exchange data with one or more computing devices over a network, the cloud-based server comprising a hardware processor coupled to non-transitory, computer-readable memory containing instructions executable by the processor to cause the server to provide a digital platform comprising an interface with which a user can interact via an associated computing device for the creation and management of a website, wherein the server is configured to:
1) receive a request for a website design, the request including website design session data based on user input with the interface, said user input comprising:
user selection of one of a plurality of types of websites to be created; and
user-provided content entered via a no-code builder for each webpage of a given selected website, said content comprising informational content and/or interactive content selected from the group consisting of text, graphics, images, video, interactive input buttons, interactive input fields, interactive links, webpage and/or website structure, webpage and/or website formatting, and webpage and/or website flow;
2) store website design session data, including user-provided content, in a database, wherein individual elements of said user-provided content are separately stored and associated with structure and formatting data of a respective webpage, and wherein structure and formatting data of a website is separately stored and associated with a respective webpage;
3) receive a request for generation of a storyboard document associated with the website design, the request including user selection of one of a plurality of storyboard document generation formats and options for each page of the storyboard document;
4) providing, in response to the user request, a plurality of individual hypertext markup language (HTML) templates for each page of said storyboard document, each of the HTML templates being populated from said stored website design session data;
5) generate, in response to user selection thereof, an HTML for each page of said storyboard document;
6) assemble each page of the storyboard document into a single HTML; and
7) generate a final storyboard document in at least one of a HTML format and a portable document format (PDF) for subsequent compliance review and approval of content.

2. The system of claim 1, wherein the plurality of types of websites comprise at least an informational-type website and an interactive-type website.

3. The system of claim 2, wherein, for an interactive-type website, the interactive content comprises text associated with a quiz, survey, and/or gamified experience.

4. The system of claim 2, wherein, for an interactive-type website, the interactive content comprises user-generated question text, user-generated answer choice text, optionally user-designated correct answers, and optionally a scoring system for user-designated correct answers.

5. The system of claim 1, wherein the interactive input buttons, interactive input fields, and/or interactive links trigger, upon end user selection thereof, associated events comprising at least one of linking to an internal or external webpage and opening a PDF or other media type.

6. The system of claim 1, wherein the webpage and/or website structure, the webpage and/or website formatting, and the webpage and/or website flow are associated with at least one of: how individual pages are interlinked; whether an end user navigates manually or automatically through the website; the manner in which an end user navigates based on interaction with a given webpage and elements thereof; appearance of headers and/or footers of a given webpage; whether a menu is present in a given webpage; and links and/or text available in a menu.

7. The system of claim 1, wherein, during storage of website design session data, the server is configured to provide the user with an option to add one or more special pages to the website.

8. The system of claim 7, wherein said one or more special pages comprises a validation page intended for validation of an end user and/or website viewer.

9. The system of claim 8, wherein said validation page comprises a default, pre-built template consisting of text and two associated interactive buttons, a first button directing an end user or website viewer to a website intended for a validated end user or website viewer upon selection thereof and a second button directing an end user or website viewer to an alternate website intended for non-validated end user or website viewer upon selection thereof.

10. The system of claim 8, wherein said validation page comprises an access-based inquiry requiring an end user or website viewer to provide input to thereby gain access to a website intended for a validated end user or website viewer.

11. The system of claim 10, wherein said access-based inquiry comprises one or more challenge questions and said input to be provided comprises one or more answers to said one or more challenge questions recognized as valid answers.

12. The system of claim 10, wherein said access-based inquiry comprises a login-based inquiry and said input to be provided comprises a recognized username and/or password.

13. The system of claim 7, wherein said one or more special pages comprises a selectable option allowing for an end user or website viewer to opt-in or register for receipt of communication, including SMS and/or email communication, concerning the content of the website.

14. The system of claim 7, wherein, for an interactive-type website, said one or more special pages comprises a selectable option providing an end user or website viewer with results of an associated survey, quiz, and/or gamified experience, and optionally one or more buttons directing an end user or website viewer to one or more websites.

15. The system of claim 1, wherein said plurality of storyboard document generation formats and options is selected from the group consisting of: user election to include an entire storyboard, in addition to mandatory individual pages, or omission of any storyboard page; user election to include one or more special pages; user election to include one or more hidden pages; user election to include a logo; user election to include a cover page with title and date of document; and user election to include notes to be appended as metadata while building pages or the entire website.

16. The system of claim 1, wherein said plurality of individual HTML templates for each type of page of said storyboard document is selected from the group consisting of: an individual page template; a menu page template; a special pop-up page template; a storyboard page template; a cover page template; and a special page template.

17. The system of claim 16, wherein the individual page template comprises multiple elements associated with content and functionality of a given webpage of the website.

18. The system of claim 17, wherein the multiple elements are selected from the group consisting of: a title of the webpage; a status of a review and/or approval process of the webpage; a preview of a full webpage in HTML display in a mobile window; a logo if selected; description of the functionality of one or more interactive elements; description of any interactive links; categories and intended audiences of content of the webpage; references, footnotes, and/or abbreviations; and notes.

19. The system of claim 18, wherein, for an interactive-type website, the multiple elements comprise descriptions of the one or more interactive elements, including descriptions of questions, answer choices, correct answers, and/or an associated scoring system.

20. The system of claim 16, wherein the storyboard page template is selected from the group consisting of: a board view template; a map view template; and a flow view template.

21. The system of claim 20, wherein:
when in a board view template, one or more pages are generated in linear format with pages shown in a left-to-right view based on navigation and titles of each page are presented in a manner to indicate association with each respective page, and, for any page not accessible via main navigation, said pages are shown vertically as sub-pages;
when in a map view template, only titles of pages are shown in a top-to-bottom view across multiple pages and sub-pages are shown to the right; and
when in a flow view template, one or more pages are generated in a linear format with pages shown in a left-to-right view based on navigation and each page is numbered and titles of each page are shown in a list on a right side of the storyboard, and, for any page no accessible via main navigation, said pages are shown vertically as sub-pages.

22. The system of claim 1, wherein the server is configured to publish the generated final storyboard document to a uniform resource locator (URL) for compliance review and approval thereof.

23. The system of claim 1, wherein the server is further configured to automatically transmit the final storyboard document for compliance review and approval of content via a third-party compliance review and approval resource.

24. The system of claim 23, wherein said third-party compliance review and approval resource comprises Veeva Vault.

25. The system of claim 1, wherein the server is configured to generate and publish a website to a URL upon successful compliance review and approval of the final storyboard document.

26. The system of claim 1, wherein the user-provided content includes endnotes comprising one or more references, footnotes, and/or abbreviations associated with a respective element provided on a given webpage, said element comprising text, an image, or a video.

27. The system of claim 26, wherein the server is configured to automatically link an endnote with a respective element of a webpage.

28. The system of claim 27, wherein the server is configured to dynamically regulate the sequential insertion of numeric characters and/or symbolic characters for a given element and tied to a corresponding reference and/or footnote, respectively.

29. The system of claim 26, wherein the server is configured to store endnotes in a dedicated endnote library.

30. The system of claim 29, wherein the server is configured to automatically create and store a full citation for a given reference based on a predefined citation format.

31. The system of claim 30, wherein the predefined citation format is in accordance with at least one of: American Psychological Association (APA) Style, Modern Language Association (MLA) Style, Chicago Style, AMA Style, and Vancouver Style.

32. The system of claim 29, wherein the server is configured to receive endnotes either manually via custom input forms provided to the user or an application programming interface (API).

33. The system of claim 32, wherein the user can input a reference via an API connection to an external database for automatic import of one or more references.

34. The system of claim 33, wherein the external database is associated with a biomedical and/or life sciences literature database.

35. The system of claim 34, wherein the external database is PubMed and the user input comprises at least one of a PubMed Identifier (PMID), a Digital Object Identifier (DOI), a Publisher Item Identifier (PII), or the title of a journal article or book to which the reference is to be associated.

36. The system of claim 33, wherein the server is configured to parse retrieved information associated with a given reference, and based on said user input, into said endnote dedicated library.

37. The system of claim 32, wherein a custom input form comprises a plurality of fields prompting the user to provide corresponding information into each field for a given endnote.

38. The system of claim 37, wherein a custom input form for a footnote comprises a first field designated for a title of the footnote and a second field designated for a complete text of the footnote.

39. The system of claim 37, wherein a custom input form for an abbreviation comprises a first field designated for the abbreviation and a second field designated for a full description of the designation.

40. The system of claim 32, wherein the user can input an abbreviation via an API connection to an external database for automatic import of one or more abbreviations.

41. The system of claim 40, wherein the external database is associated with a biomedical and/or life sciences literature database.
